(19) United States
(12) Patent Application Publication
(10) Pub. No.: US 2017/0212459 A1
(43) Pub. Date: Jul. 27, 2017

(54) FIXING DEVICE, IMAGE FORMING APPARATUS, AND HEATING DEVICE

(71) Applicant: FUJI XEROX CO., LTD., Tokyo (JP)

(72) Inventors: Shuichi YAMADA, Kanagawa (JP); Takehiro NIITSU, Kanagawa (JP); Koichi HAGA, Kanagawa (JP); Kazuhiro HAYASHI, Kanagawa (JP); Mutsuya TAKAHASHI, Kanagawa (JP); Michiaki MURATA, Kanagawa (JP)

(73) Assignee: FUJI XEROX CO., LTD., Tokyo (JP)

(21) Appl. No.: 15/229,334

(22) Filed: Aug. 5, 2016

(30) Foreign Application Priority Data
Jan. 26, 2016 (JP) 2016-012579

(51) Int. Cl. G03G 15/20

(52) U.S. Cl. CPC G03G 15/2057

(57) ABSTRACT

A fixing device includes a heating member that includes a substrate having a substantially flat portion and a recess in a surface on one side, a heating body provided on the substantially flat portion of the substrate and that generates heat with a supply of electric current, a resistive element provided in the recess of the substrate and that is connected in series to the heating body, the resistive element having a positive temperature coefficient, and a protective layer provided over the heating body and the resistive element and that protects the heating body and the resistive element; a belt member that is heated by being in contact with the surface, on the one side, of the substrate of the heating member, the belt member being rotatable; and a pressing member that is pressed against the belt member and forms a nip part.

### CROSS-REFERENCE TO RELATED APPLICATIONS

This application is based on and claims priority under 35 USC 119 from Japanese Patent Application No. 2016-012579 filed Jan. 26, 2016.

### BACKGROUND

### Technical Field

The present invention relates to a fixing device, an image forming apparatus, and a heating device.

### SUMMARY

According to an aspect of the invention, there is provided a fixing device including a heating member that includes a substrate having a substantially flat portion and a recess in a surface on one side, a heating body provided on the substantially flat portion of the substrate and that generates heat with a supply of electric current, a resistive element provided in the recess of the substrate and that is connected in series to the heating body, the resistive element having a positive temperature coefficient, and a protective layer provided over the heating body and the resistive element and that protects the heating body and the resistive element; a belt member that is heated by being in contact with the surface, on the one side, of the substrate of the heating member, the belt member being rotatable; and a pressing member that is pressed against the belt member and forms a nip part.

### BRIEF DESCRIPTION OF THE DRAWINGS

Exemplary embodiments of the present invention will be described in detail based on the following figures, wherein:

FIG. 1 is a schematic sectional view of an image forming apparatus according to a first exemplary embodiment of the present invention;

FIG. 2 is a sectional view of a fixing unit included in the image forming apparatus;

FIG. 3A is a top view of a solid heater according to the first exemplary embodiment seen in a direction of arrow IIIA illustrated in FIG. 2;

FIG. 3B is a sectional view of the solid heater taken along line IIIB-IIIB illustrated in FIG. 3A;

FIG. 4A is a top view of a solid heater according to a first comparative embodiment seen in the direction of arrow IIIA illustrated in FIG. 2;

FIG. 4B is a sectional view of the solid heater taken along line IVB-IVB illustrated in FIG. 4A;

FIG. 5A is a top view of a solid heater according to a second comparative embodiment seen in the direction of arrow IIIA illustrated in FIG. 2;

FIG. 5B is a sectional view of the solid heater taken along line VB-VB illustrated in FIG. 5A;

FIG. 6 is a flow chart illustrating exemplary steps of manufacturing the solid heater;

FIG. 7 is a flow chart illustrating other exemplary steps of manufacturing the solid heater that follow the steps illustrated in FIG. 6;

FIGS. 8A1, 8B1, 8C1, and 8D1 are top views illustrating corresponding ones of the steps of manufacturing the solid heater;

FIGS. 8A2, 8B2, 8C2, and 8D2 are sectional views taken along respective lines VIIIA2-VIIIA2, VIIIB2-VIIIB2, VIIIC2-VIIIC2, and VIIID2-VIIID2 illustrated in FIGS. 8A1, 8B1, 8C1, and 8D1;

FIGS. 9A1, 9B1, 9C1, and 9D1 are top views illustrating corresponding ones of the steps of manufacturing the solid heater that follow the steps illustrated in FIGS. 8A1, 8B1, 8C1, and 8D1;

FIGS. 9A2, 9B2, 9C2, 9D2, and 9D3 are sectional views taken along respective lines IXA2-IXA2, IXB2-IXB2, IXC2-IXC2, IXD2-IXD2, and IXD3-IXD3 illustrated in FIGS. 9A1, 9B1, 9C1, and 9D1;

FIG. 10 is a graph illustrating the characteristic of PTC elements; and

FIG. 11 is a top view of a solid heater according to a second exemplary embodiment of the present invention.

### DETAILED DESCRIPTION

### First Exemplary Embodiment

### Image Forming Apparatus 1

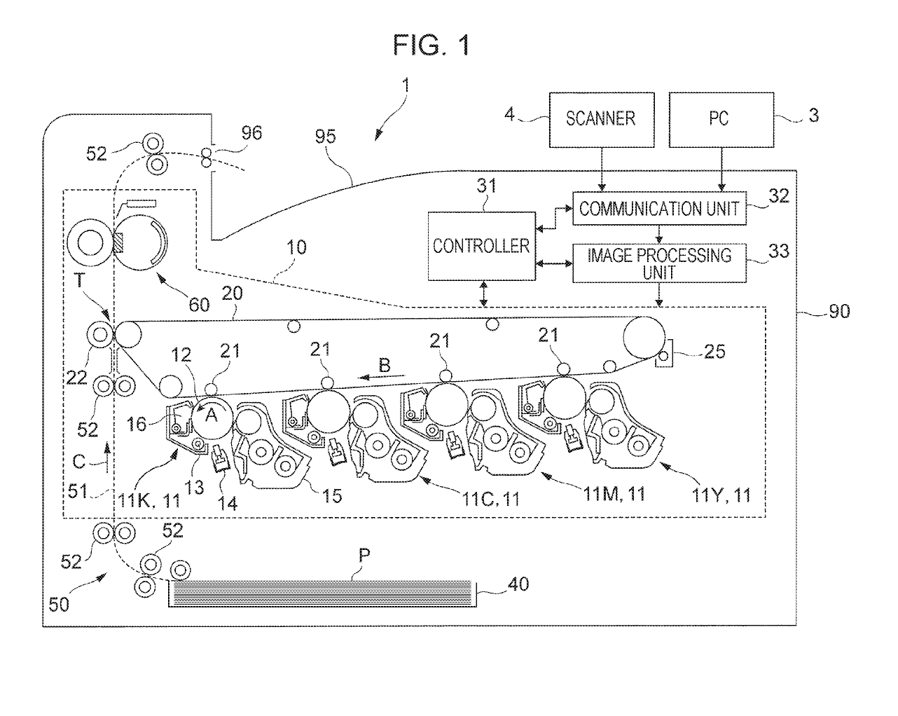

FIG. 1 is a schematic sectional view of an image forming apparatus 1 according to a first exemplary embodiment of the present invention. The image forming apparatus 1 is an electrophotographic color printer that prints images on the basis of image data.

The image forming apparatus 1 includes a body case 90, in which a sheet container unit 40 that contain sheets P (exemplary recording media), an image forming section 10 that forms an image on each of the sheets P, and a transporting section 50 that transports the sheet P from the sheet container unit 40 through the image forming section 10 up to a sheet output port 96 provided in the body case 90. The image forming apparatus 1 further includes a controller 31 that controls the entire operation of the image forming apparatus 1, a communication unit 32 that communicates with, for example, a personal computer (PC) 3 or an image reading apparatus (scanner) 4 and receives image data therefrom, and an image processing unit 33 that processes the image data received by the communication unit 32.

The sheet container unit 40 contains sheets P.

The transporting section 50 includes a sheet transport path 51 extending from the sheet container unit 40, passing through the image forming section 10, and reaching the sheet output port 96; and pairs of transport rollers 52 that transport the sheet P along the transport path 51. The transporting section 50 transports the sheet P in a direction represented by arrow C.

The image forming section 10 includes four image forming units 11Y, 11M, 11C, and 11K that are arranged at predetermined intervals. The image forming units 11Y, 11M, 11C, and 11K are hereinafter collectively referred to as “image forming units 11” if there is no need to distinguish thereamong. The image forming units 11 each include a photoconductor drum 12 on which an electrostatic latent image to be developed into a toner image is formed, a charging device 13 that charges the surface of the photoconductor drum 12 with a predetermined potential, a light-emitting-diode (LED) printhead 14 that exposes the photoconductor drum 12 charged by the charging device 13 to light emitted therefrom on the basis of a corresponding one of pieces of image data for different colors, a developing device 15 that develops the electrostatic latent image on the photoconductor drum 12 into a toner image, and a drum cleaner 16 that cleans the surface of the photoconductor drum 12 after a transfer process is performed.

The four image forming units 11Y, 11M, 11C, and 11K all have the same configuration, except toners contained in the respective developing devices 15. The image forming unit 11Y including the developing device 15 that contains a yellow (Y) toner forms a yellow toner image. Likewise, the image forming unit 11M including the developing device 15 that contains a magenta (M) toner forms a magenta toner image, the image forming unit 11C including the developing device 15 that contains a cyan (C) toner forms a cyan toner image, and the image forming unit 11K including the developing device 15 that contains a black (K) toner forms a black toner image.

The image forming section 10 further includes an intermediate transfer belt 20 to which the toner images in the respective colors on the respective photoconductor drums 12 of the respective image forming units 11 are transferred in such a manner as to be superposed one on top of another, and first transfer rollers 21 that sequentially electrostatically transfer the toner images in the respective colors formed by the respective image forming units 11 to the intermediate transfer belt 20 (first transfer). The image forming section 10 further includes a second transfer roller 22 provided in a second transfer part T and that electrostatically transfers the toner images in the respective colors superposed on the intermediate transfer belt 20 to a sheet P collectively (second transfer), and a fixing unit 60 (an exemplary fixing portion and an exemplary fixing device) that fixes the superposed toner images transferred to the sheet P in the second transfer.

The image forming apparatus 1 performs the following image forming process under the control of the controller 31. Specifically, image data transmitted from the PC 3 or the scanner 4 is received by the communication unit 32 and is processed in a predetermined manner by the image processing unit 33, whereby pieces of image data for the respective colors are generated. The pieces of image data for the respective colors are transmitted to the respective image forming units 11 provided for the respective colors. Subsequently, in the image forming unit 11K that forms a black toner image, for example, the photoconductor drum 12 rotating in a direction of arrow A is charged with a predetermined potential by the charging device 13.

Subsequently, the LED printhead 14 performs scan exposure on the photoconductor drum 12 on the basis of black image data transmitted from the image processing unit 33, whereby an electrostatic latent image corresponding to the black image data is formed on the photoconductor drum 12. The electrostatic latent image for black on the photoconductor drum 12 is then developed into a black toner image by the developing device 15. Likewise, the image forming units 11Y, 11M, and 11C form yellow (Y), magenta (M), and cyan (C) toner images, respectively.

The toner images in the respective colors thus formed on the photoconductor drums 12 of the image forming units 11 are sequentially electrostatically transferred to the intermediate transfer belt 20 by the respective first transfer rollers 21 in such a manner as to be superposed one on top of another while the intermediate transfer belt 20 is rotating in a direction of arrow B, whereby a set of superposed toner images in the respective colors is formed on the intermediate transfer belt 20.

With the rotation of the intermediate transfer belt 20 in the direction of arrow B, the set of superposed toner images on the intermediate transfer belt 20 is transported to the second transfer part T (an exemplary transfer portion). Synchronously with the transport of the set of superposed toner images to the second transfer part T, a sheet P is transported from the sheet container unit 40 in the direction of arrow C along the transport path 51 by the pairs of transport rollers 52 provided in the transporting section 50. Then, the set of superposed toner images on the intermediate transfer belt 20 is collectively electrostatically transferred, with a transfer electric field produced by the second transfer roller 22 at the second transfer part T, to the sheet P transported along the transport path 51.

Subsequently, the sheet P carrying the set of superposed toner images that has been electrostatically transferred thereto is transported along the transport path 51 to the fixing unit 60. The set of superposed toner images on the sheet P transported to the fixing unit 60 is subjected to heat and pressure applied thereto by the fixing unit 60, whereby the set of superposed toner images is fixed on the sheet P. The sheet P having the fixed set of superposed toner images is transported along the transport path 51 in the direction of arrow C and is discharged from the sheet output port 96 provided in the body case 90 onto a sheet stacking portion 95 that receives the sheet P.

Meanwhile, toner particles remaining on the photoconductor drums 12 after the first transfer and toner particles remaining on the intermediate transfer belt 20 after the second transfer are removed by the drum cleaners 16 and a belt cleaner 25.

The above image forming process performed by the image forming apparatus 1 for printing an image on a sheet P is repeated a number of times corresponding to the number of pages to be printed.

### Fixing Unit 60

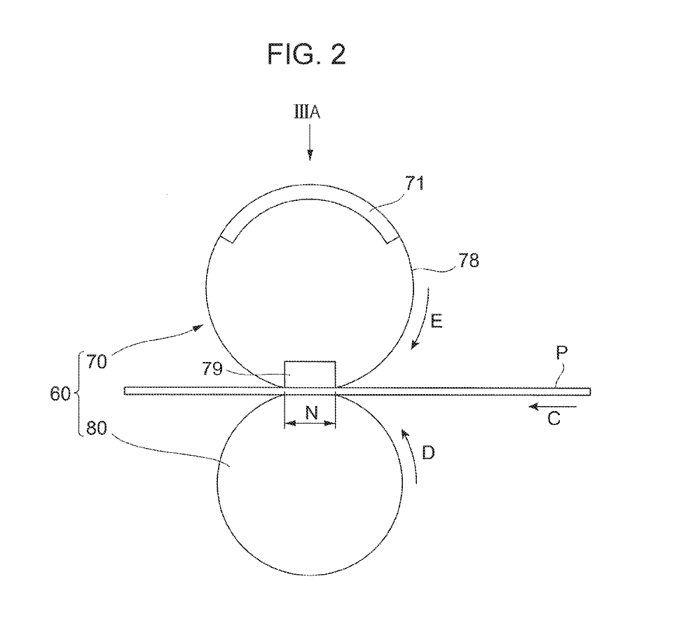

FIG. 2 is a sectional view of the fixing unit 60 included in the image forming apparatus 1.

The fixing unit 60 includes a heater unit 70 and a pressure roller 80 (an exemplary pressing member). The heater unit 70 and the pressure roller 80 each have a round columnar shape whose axis extends in the depth direction in FIG. 2.

The heater unit 70 includes a rotating fixing belt 78 (an exemplary heating object and an exemplary belt member), a heat-generating solid heater 71 (an exemplary heating member and an exemplary heating device) that has an arc or substantially arc shape in sectional view taken in the direction of rotation of the fixing belt 78, and a pressure pad 79 that is pressed by the pressure roller 80 with the fixing belt 78 interposed therebetween. The surface of the solid heater 71 only needs to have an arc or substantially arc shape in the direction of rotation of the fixing belt 78. The surface of the solid heater 71 may have a circular arc shape.

The solid heater 71 described below is provided in the form of a plate-like member so that the heat capacity is reduced.

The fixing belt 78 has an endless cylindrical shape, and the inner circumferential surface thereof is in contact with the outer circumferential surface of the solid heater 71 and with the pressure pad 79. The fixing belt 78 is heated by coming into contact with the solid heater 71.

The fixing belt 78 is an endless belt member whose original shape is cylindrical. For example, in the original shape (cylindrical shape), the fixing belt 78 has a diameter of 30 mm and a widthwise length of 300 mm. As described below, the fixing belt 78 deforms when pressed by the pressure pad 79. The term “original shape” used herein refers to a shape of the fixing belt 78 that is not pressed by the pressure pad 79, that is, an undeformed shape.

The fixing belt 78 includes a base layer and a release layer provided over the base layer. The base layer is a heat-resistant sheet-like member providing a certain level of mechanical strength to the fixing belt 78 as a whole. The base layer is, for example, a polyimide resin sheet having a thickness of 60 μm to 200 μm. To make the temperature distribution of the fixing belt 78 evener, a heat-conductive filler made of aluminum or the like may be added to the polyimide resin.

The release layer directly comes into contact with the set of toner images yet to be fixed on the sheet P and is therefore made of a highly releasable material. For example, any of the following: tetrafluoroethylene perfluoroalkylvinylether copolymer (PFA), polytetrafluoroethylene (PTFE), or silicone copolymer; or any combination of the foregoing materials. If the release layer is too thin, the wear resistance of the release layer is insufficient, resulting in a short life of the fixing belt 78. If the release layer is too thick, the heat capacity of the fixing belt 78 becomes too large, leading to a long warmup time. Considering the balance between the wear resistance and the heat capacity, the thickness of the release layer may be set to 1 μm to 50 μm.

In addition, an elastic layer made of silicone rubber or the like may be interposed between the base layer and the release layer.

The pressure pad 79 is made of, for example, silicone rubber or fluorocarbon rubber, or so-called engineering plastic having high mechanical strength and high heat resistance. For example, the pressure pad 79 is a rigid block member made of a material such as phenolic resin, polyimide resin, polyamide resin, polyamideimide resin, polyether ether ketone (PEEK) resin, polyether sulfone (PES) resin, polyphenylene sulfide (PPS) resin, or liquid crystal polymer (LCP) resin, and a surface of the pressure pad 79 that is in contact with the fixing belt 78 has a substantially arc shape in sectional view. The pressure pad 79 is supported by a frame (not illustrated) on the inner side of the fixing belt 78. The pressure pad 79 is fixedly provided in an area where the pressure roller 80 presses the fixing belt 78, and extends in the axial direction of the pressure roller 80 over the entirety of the area. The pressure pad 79 presses the pressure roller 80 with the fixing belt 78 interposed therebetween and at a predetermined load (for example, an average of 10 kgf) evenly over the entirety of an area having a predetermined width.

The pressure roller 80 is provided against the fixing belt 78 and rotates at a process speed of, for example, 140 mm/s in a direction of arrow D illustrated in FIG. 2 by following the rotation of the fixing belt 78. The pressure roller 80 and the pressure pad 79 are pressed against each other with the fixing belt 78 interposed therebetween, whereby a nip part (press-fixing part) N is formed.

The pressure roller 80 includes, for example, a core (columnar core metal), a heat-resistant elastic layer provided over the core, and a release layer provided over the elastic layer. The core is made of solid stainless steel or aluminum and has a diameter of 18 mm. The elastic layer is made of silicone sponge or the like and has a thickness of, for example, 5 mm. The release layer is a heat-resistant resin coating, such as PFA containing carbon, or a heat-resistant rubber coating. The release layer has a thickness of, for example, 50 μm. Thus, the pressure roller 80 presses the pressure pad 79, with the fixing belt 78 interposed therebetween, at a load of, for example, 25 kfg with the aid of a pressing spring (not illustrated).

The sheet P transported to the nip part N by the transporting section 50 (see FIG. 1) is heated by the fixing belt 78 at the nip part N and is pressed between the pressure pad 79 and the pressure roller 80 together with the fixing belt 78. Thus, the set of unfixed superposed toner images carried by the sheet P is fixed.

At the nip part N, the sheet P that is in contact with the pressure roller 80 is moved in the direction of arrow C with the rotation of the pressure roller 80 in the direction of arrow D. The movement of the sheet P causes the fixing belt 78 that is in contact with the sheet P to rotate in a direction of arrow E (a direction of forward rotation).

### Solid Heater 71

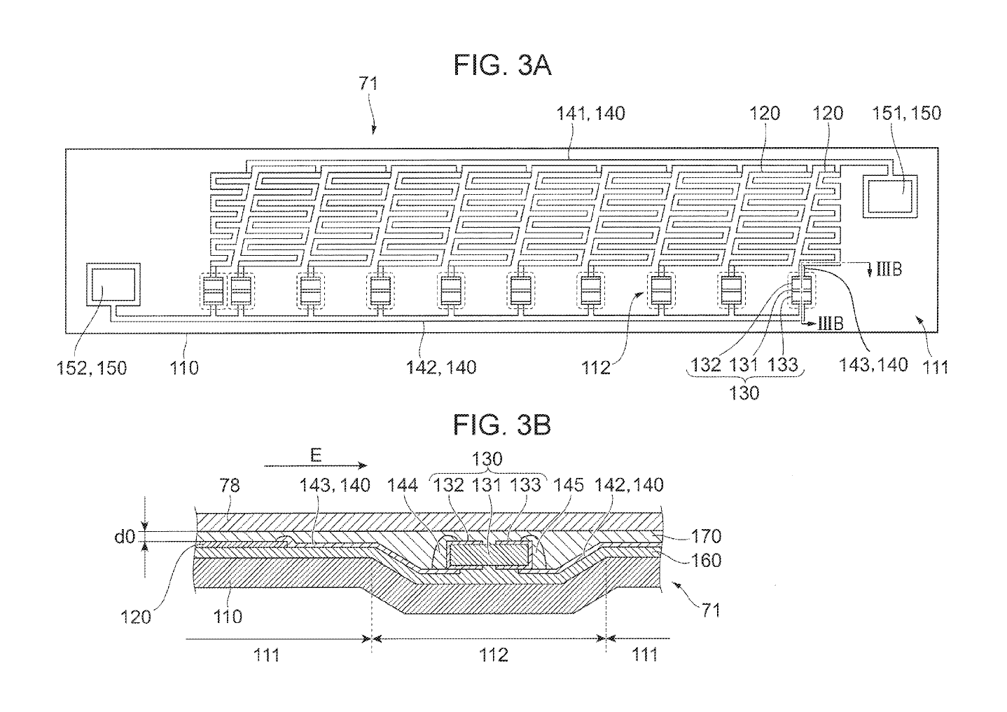

FIGS. 3A and 3B illustrate the solid heater 71 according to the first exemplary embodiment. FIG. 3A is a top view of the solid heater 71 seen in a direction of arrow IIIA illustrated in FIG. 2. FIG. 3B is a sectional view of the solid heater 71 taken along line IIIB-IIIB illustrated in FIG. 3A.

As illustrated in FIG. 2, the solid heater 71 has an arc or substantially arc shape in the sectional taken in the direction of rotation of the fixing belt 78. However, the solid heater 71 illustrated in FIG. 3B is flat, because FIG. 3B illustrates only a part of the solid heater 71.

Referring to FIG. 3A, a configuration on the upper side of the solid heater 71 will now be described. The solid heater 71 includes plural resistive heating bodies 120 (exemplary heating bodies), plural positive-temperature-coefficient (PTC) elements 130 (exemplary resistive elements each having a positive temperature coefficient), wiring lines 140 connecting the foregoing elements, terminals 150 connected to the wiring lines 140, and a substrate 110 supporting the forgoing elements. The resistive heating bodies 120, the PTC elements 130, the wiring lines 140, and the terminals 150 are all provided on one side of the substrate 110.

The resistive heating bodies 120 are each made of, for example, AgPd with a high ratio of Pd. When an electric current is supplied to the resistive heating body 120, the resistive heating body 120 generates heat.

The PTC elements 130 are each a resistive element whose resistance increases with the rise of temperature. The PTC element 130 is occasionally referred to as thermistor having a positive temperature coefficient. A body portion 131 of the PTC element 130 is made of, for example, barium titanate (BaTiO₃) containing a very small amount of rare earth or the like. When the temperature of the body portion 131 goes over the Curie point, the resistance of the PTC element 130 rapidly increases.

The PTC element 130 is of a chip type and has a size of, for example, 2 mm (length) by 2 mm (width) by 0.2 mm (thickness). The PTC element 130 further includes an electrode 132 and an electrode 133 that are provided in advance on two respective sides (on the upper and lower sides in FIG. 3A, and on the left and right sides in FIG. 3B) of the body portion 131. The electrodes 132 and 133 are made of, for example, Ag provided on a Ni plate serving as an underlayer. In an environment with no rise of temperature, the resistance value of the PTC element 130 is determined by the distance between the electrodes 132 and 133. Specifically, in the environment with no rise of temperature, the shorter the distance between the electrodes 132 and 133, the smaller the resistance of the PTC element 130.

While the electrodes 132 and 133 illustrated in FIG. 3B each have a rectangular U shape extending around the body portion 131, the electrodes 132 and 133 may each have another shape. For example, the electrodes 132 and 133 may each extend only over a side face and a top face of the body portion 131. The electrodes 132 and 133 only need to be electrically connected to wiring lines 143 and 142, respectively, with the aid of connection wiring lines 144 and 145, respectively, which will be described later.

The wiring lines 140 are each made of, for example, AgPd with a low ratio of Pd. The wiring lines 140 include a wiring line 141 provided on the upper side in FIG. 3A, the wiring line 142 provided on the lower side in FIG. 3A, and the wiring lines 143 each provided between a corresponding one of the resistive heating bodies 120 and a corresponding one of the PTC elements 130. As illustrated in FIG. 3B, the wiring lines 140 further include the wiring lines 144 each connecting a corresponding one of the wiring lines 143 and the electrode 132 of a corresponding one of the PTC elements 130 to each other, and the wiring lines 145 each connecting the wiring line 142 and the electrode 133 of a corresponding one of the PTC elements 130 to each other. The wiring lines 144 and 145 are occasionally referred to as connection electrodes.

In FIGS. 3A and 3B, the wiring lines 141 to 143 are denoted by 141,140, 142,140, and the like. Occasionally, the wiring lines 141 to 143 may be denoted without 140. If there is no need to distinguish the wiring lines 141 to 145 from one another, the wiring lines are denoted by 140.

Each of the resistive heating bodies 120 and a corresponding one of the PTC elements 130 are electrically connected in series and are thus paired. The pairs of the resistive heating bodies 120 and the PTC elements 130 are connected in parallel between the wiring line 141 and the wiring line 142.

The wiring lines 140 will be described later with reference to FIG. 3B.

The terminals 150 are each an exposed portion of a corresponding one of the wiring lines 140 (the wiring lines 141 and 142), the exposed portion not being covered with a protective layer 170 (see FIG. 3B referred to later). The terminals 150 include a terminal 151 provided at an end of the wiring line 141, and a terminal 152 connected to the wiring line 142. In FIG. 3A, the terminals 151 and 152 are denoted by 151,150 and 152,150, respectively.

The terminals 150 are each a part of a corresponding one of the wiring lines 140 (the wiring lines 141 and 142) that is widened for easy connection to a wire provided for the supply of an electric current.

When a voltage is applied between the terminal 151 and the terminal 152, a current flows through each of the pairs of the resistive heating bodies 120 and the PTC elements 130 that are electrically connected in series. Thus, the resistive heating bodies 120 generate heat.

The voltage applied between the terminal 151 and the terminal 152 is, for example, an alternating current (AC) of 100 V.

The resistive heating bodies 120 that are at the left and right ends, respectively, in FIG. 3A have different shapes from the other resistive heating bodies 120, because no heat needs to be generated in regions of the solid heater 71 that correspond to regions of the fixing belt 78 where the sheet P does not pass. That is, the length of an area between the resistive heating bodies 120 at the left and right ends inclusive corresponds to the maximum width of the sheet P that is handleable by the image forming apparatus 1. The resistive heating bodies 120 at the left and right ends may have the same shape as the other resistive heating bodies 120.

Now, functions of the PTC elements 130 will be described.

The PTC elements 130 each have a resistance that increases with the rise of temperature. Hence, when the solid heater 71 is heated to a temperature at or above a predetermined level by the resistive heating bodies 120, the resistances of the PTC elements 130 increase and restrict the current flowing through the resistive heating bodies 120 connected in series to the respective PTC elements 130. Therefore, the amount of heat generated by the resistive heating bodies 120 is reduced, and the temperature of the resistive heating bodies 120 drops. Accordingly, the resistances of the PTC elements 130 decrease. Then, the current flowing through the resistive heating bodies 120 increases, and the temperature of the resistive heating bodies 120 rises. That is, the PTC elements 130 suppress the overheating of the solid heater 71.

When the sheet P is heated by the fixing belt 78 at the nip part N of the fixing unit 60, the fixing belt 78 is deprived of heat by the sheet P. Hence, the temperature of the fixing belt 78 drops. The fixing belt 78 whose temperature has dropped is reheated to a predetermined temperature by the solid heater 71.

However, if a sheet P whose width is smaller than the maximum width is transported to the fixing unit 60, some regions of the fixing belt 78 are kept out of contact with the sheet P and are not deprived of heat by the sheet P. Such regions of the fixing belt 78 that are kept out of contact with the sheet P remain heated and are eventually reaches a temperature above the predetermined level by the solid heater 71 (the regions are overheated). In such an event, not only the fixing belt 78 but also the solid heater 71 is overheated.

To prevent such a situation, the solid heater 71 according to the first exemplary embodiment includes the plural resistive heating bodies 120 that are separate from one another and are arranged side by side in the longitudinal direction of the solid heater 71, with the PTC elements 130 connected in series to the respective resistive heating bodies 120.

Accordingly, in the overheated regions of the fixing belt 78 where the sheet P is out of contact, the resistances of the PTC elements 130 increase and thus restrict the current flowing through the resistive heating bodies 120, whereby further overheating of the solid heater 71 and the fixing belt 78 is suppressed.

Meanwhile, in the region of the fixing belt 78 where the sheet P is in contact, the current flowing through the resistive heating bodies 120 is not restricted. Therefore, the solid heater 71 and the fixing belt 78 continue to be heated.

Hence, the PTC elements 130 need to be provided near the respective resistive heating bodies 120 on the substrate 110 of the solid heater 71. Therefore, in the solid heater 71 according to the first exemplary embodiment, the PTC elements 130 are provided in respective recesses 112 provided near the respective resistive heating bodies 120.

Referring now to FIG. 3B, a sectional configuration of the solid heater 71 will be described. The substrate 110 of the solid heater 71 has the recesses 112 in regions thereof where the PTC elements 130 are mounted. The other regions, excluding the recesses 112, of the substrate 110 are referred to as flat or substantially flat portions 111 (hereinafter simply referred to as the flat portions 111). The substrate 110 is provided with an insulating layer 160 spreading evenly thereover. The resistive heating bodies 120, the wiring lines 140 (the wiring lines 141, 142, 143, 144, and 145), and the PTC elements 130 are provided on the insulating layer 160.

The wiring line 141 is connected to a first end of each of the resistive heating bodies 120 (see FIG. 3A). The wiring line 142 extends up to a position below the electrode 133 of each of the PTC elements 130. A first end of each of the wiring lines 143 is connected to a second end of a corresponding one of the resistive heating bodies 120. A second end of each of the wiring lines 143 extends up to a position below the electrode 132 of a corresponding one of the PTC elements 130.

The wiring lines 144 each connect a corresponding one of the wiring lines 143 and the electrode 132 of a corresponding one of the PTC elements 130 to each other at a side face and/or the top face of the PTC element 130. Likewise, the wiring lines 145 each connect the wiring line 142 and the electrode 133 of a corresponding one of the PTC elements 130 to each other at a side face and/or a top face of the PTC element 130.

Note that FIG. 3B does not illustrate the wiring line 141, which is provided outside the region illustrated in FIG. 3B.

The protective layer 170 is provided over the resistive heating bodies 120, the PTC elements 130, and the wiring lines 140.

The surface of the protective layer 170 (a side farther from the substrate 110) is even and smooth (level or substantially level, hereinafter simply referred to as level) with suppressed irregularities, as to be described later.

The substrate 110 is made of, for example, stainless steel (SUS). The recesses 112 of the substrate 110 are provided by performing pressing at respective positions where the PTC elements 130 are to be mounted.

The substrate 110 may be made of a metal material other than stainless steel (SUS). For example, the substrate 110 may be made of aluminum or copper. Alternatively, the substrate 110 may be made of a ceramic material that is baked in such a manner as to have the recesses 112, or may be made of a heat-resistant plastic material that is shaped in such a manner as to have the recesses 112.

If the substrate 110 is made of a conductive metal material such as stainless steel (SUS), the insulating layer 160 suppresses the occurrence of electrical short circuit between the substrate 110 and the resistive heating bodies 120, the PTC elements 130, and the wiring lines 140 (the wirings 141, 142, and 143). If the substrate 110 is made of an insulating material such as ceramic, the insulating layer 160 may be omitted. Hence, a combination of the substrate 110 and the insulating layer 160 may be referred to as the substrate, and the resistive heating bodies 120 and the PTC elements 130 provided on the insulating layer 160 may be regarded as being provided on the substrate.

If the substrate 110 is made of heat-resistant metal such as stainless steel (SUS), the insulating layer 160 is made of, for example, a glass material. If the insulating layer 160 is made of a glass material, the insulating layer 160 may be also referred to as underglaze.

The protective layer 170 prevents the elements such as the resistive heating bodies 120 and the PTC elements 130 from coming into direct contact with the fixing belt 78. For example, to allow the fixing belt 78 and the solid heater 71 to smoothly slide against each other, lubricant such as silicone oil may be supplied to the contact part between the solid heater 71 and the fixing belt 78. In such a case, unless the protective layer 170 is provided, electrical short circuit may occur between the elements such as the resistive heating bodies 120 and the PTC elements 130.

If the substrate 110 is made of heat-resistant metal such as stainless steel (SUS), the protective layer 170 is made of, for example, a glass material. If the protective layer 170 is made of a glass material, the protective layer 170 may be also referred to as overglaze.

In the solid heater 71 according to the first exemplary embodiment, as illustrated in FIG. 3B, regions of the protective layer 170 that are above the resistive heating bodies 120 each have a thickness d0. That is, the distance between the fixing belt 78 and each of the resistive heating bodies 120 is equal to the thickness d0 of each of the regions of the protective layer 170 that are above the resistive heating bodies 120.

The thickness of the protective layer 170 is not uniform. As to be described later, regions of the protective layer 170 that are around the respective PTC elements 130 are thicker than the other regions of the protective layer 170. Thus, the protective layer 170 has an even and smooth (level) surface with suppressed irregularities.

Since the PTC elements 130 are placed in the respective recesses 112 and the surface of the protective layer 170 is made even and smooth (level) with suppressed irregularities, the distance between the fixing belt 78 and each of the resistive heating body 120 is set to d0.

To form the insulating layer 160 or the protective layer 170 from a glass material, glass paste in which glass particles are dispersed is applied to the substrate 110, and the glass paste is heated so as to be softened (fused) and to be fluidized (to undergo viscous flow). In such a method, since the glass particles that are softened are fused together, the insulating layer 160 or the protective layer 170 having undergone viscous flow comes to have a finer structure that has an even and smooth (level) surface with suppressed irregularities.

The insulating layer 160 has a thickness of, for example, 15 μm to 70 μm. The resistive heating bodies 120 and the wiring lines 140 each have a thickness of 10 μm to 30 μm. The PTC elements 130 each have a thickness of about 0.2 mm, as described above.

That is, the depth of the recesses 112 provided in the substrate 110 is set so as to be slightly greater than the thickness of the PTC elements 130. For example, if the thickness of the PTC elements 130 is 0.2 mm, the depth of the recesses 112 is set to 0.25 mm. Thus, the PTC elements 130 are embedded in the respective recesses 112.

Then, the protective layer 170 is formed in such a manner as to have an even and smooth (level) surface with suppressed irregularities.

The PTC elements 130 do not necessarily need to be completely embedded in the recesses 112. The surface irregularities of the protective layer 170 only need to be reduced with the presence of the recesses 112.

As described above, the fixing belt 78 includes the base layer made of, for example, polyimide resin and is therefore easily deformable. Hence, unless the contact between the fixing belt 78 and the solid heater 71 is hindered, the surface of the protective layer 170 at the recesses 112 does not need to be flat and parallel to the flat portions 111 and may be concave toward the substrate 110 or convex from the substrate 110.

The fixing belt 78 and the solid heater 71 only need to smoothly slide against each other so that heat efficiently conducts from the solid heater 71 to the fixing belt 78.

That is, the phrase “an even and smooth (level) surface with suppressed irregularities” encompasses that the surface of the protective layer 170 at the recesses 112 is convex or concave.

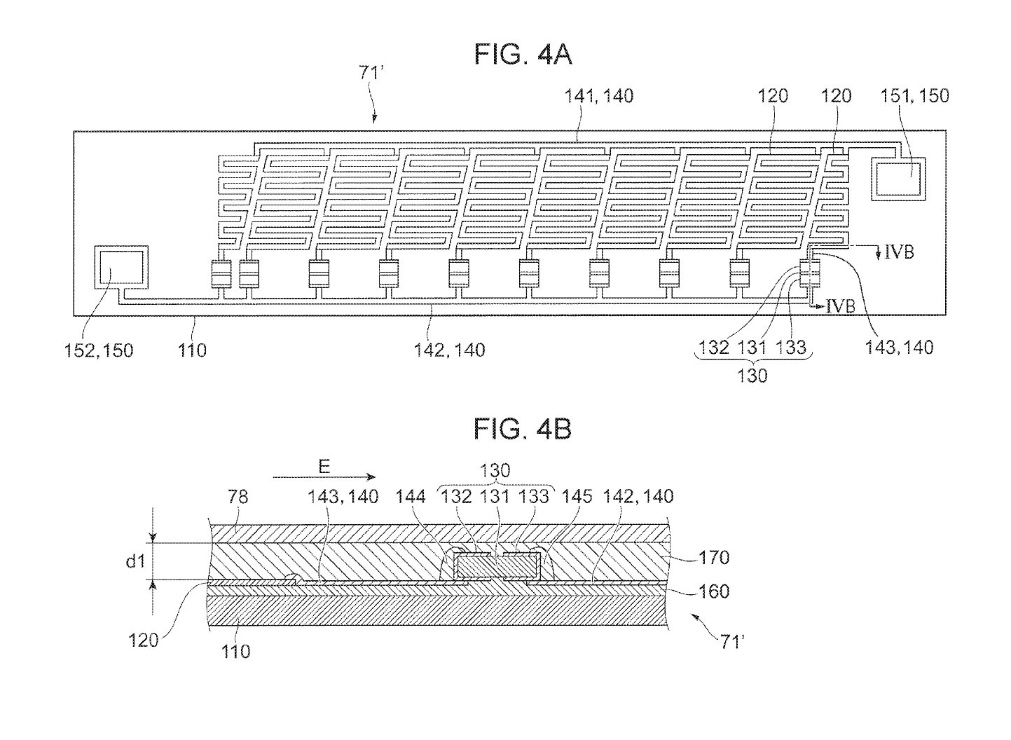

FIGS. 4A and 4B illustrate a solid heater 71′ according to a first comparative embodiment. FIG. 4A is a top view of the solid heater 71′ seen in the direction of arrow IIIA illustrated in FIG. 2. FIG. 4B is a sectional view of the solid heater 71′ taken along line IVB-IVB illustrated in FIG. 4A.

As illustrated in FIG. 4A, the substrate 110 of the solid heater 71′ has no recesses 112. As illustrated in FIG. 4B, the protective layer 170 has a thickness d1 so as to have a flat (even and smooth) surface with the PTC elements 130 embedded therein. That is, the distance between the fixing belt 78 and each of the resistive heating bodies 120 is equal to the thickness d1 of the protective layer 170. The thickness d1 is greater than the thickness d0 of the protective layer 170 included in the solid heater 71 according to the first exemplary embodiment illustrated in FIGS. 3A and 3B.

In the solid heater 71′ according to the first comparative embodiment, the contact surface between the fixing belt 78 and the solid heater 71′ is an even and smooth (level) surface with suppressed irregularities, as with the solid heater 71 according to the first exemplary embodiment. Therefore, the fixing belt 78 and the solid heater 71′ smoothly slide against each other.

However, in the solid heater 71′ according to the first comparative embodiment, since the protective layer 170 is as thick as the thickness d1 and has a large heat capacity, it takes a long time and a large amount of energy to heat the protective layer 170. In addition, the long distance between the fixing belt 78 and each of the resistive heating bodies 120 lowers the efficiency in the heat conduction from the resistive heating bodies 120 to the fixing belt 78.

Moreover, a large amount of glass material that is necessary for forming the protective layer 170 increases the manufacturing cost.

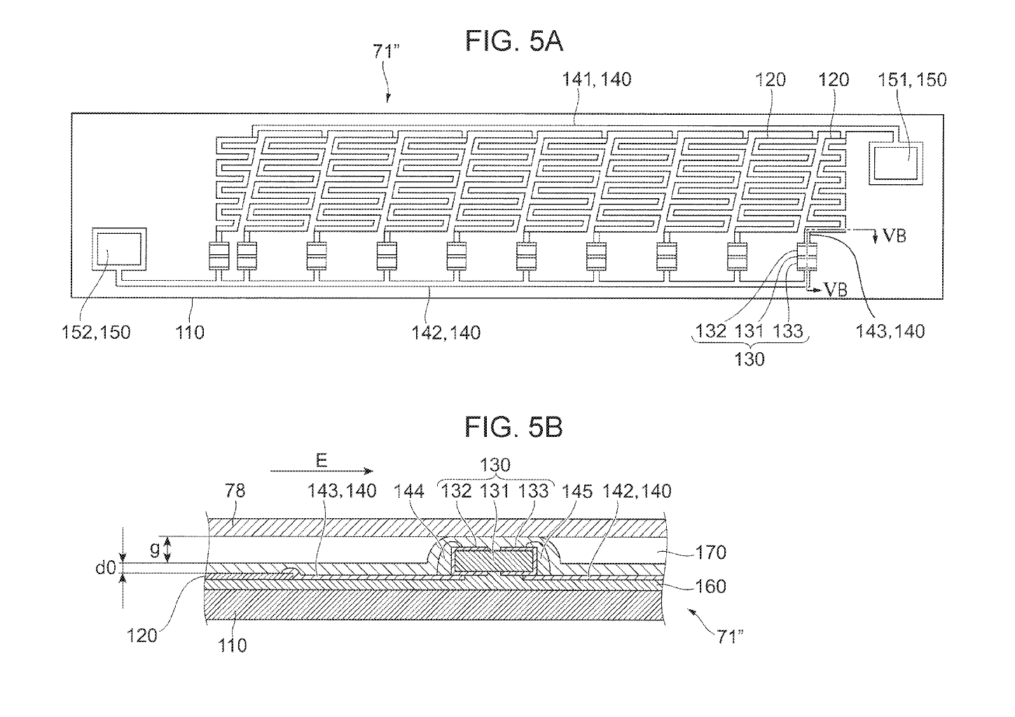

FIGS. 5A and 5B illustrate a solid heater 71″ according to a second comparative embodiment. FIG. 5A is a top view of the solid heater 71″ seen in the direction of arrow IIIA illustrated in FIG. 2. FIG. 5B is a sectional view of the solid heater 71″ taken along line VB-VB illustrated in FIG. 5A.

As illustrated in FIG. 5A, the substrate 110 of the solid heater 71″ has no recesses 112. As illustrated in FIG. 5B, the protective layer 170 has the thickness d0 in regions thereof above the resistive heating bodies 120. However, since the PTC elements 130 are not embedded in the substrate 110, the PTC elements 130 project toward the outer side (toward the fixing belt 78) with respect to the resistive heating bodies 120. That is, there are gaps, i.e., a distance g, between the fixing belt 78 and the protective layer 170 in areas around the PTC elements 130 and above the resistive heating bodies 120. The gaps prevent the heat conduction from the resistive heating bodies 120 to the fixing belt 78 and lower the efficiency in the heat conduction from the resistive heating bodies 120 to the fixing belt 78.

As described above, the fixing belt 78 is made of a material that is easy to deform but is difficult to completely conform to the convex shape of each of the PTC elements 130. Therefore, if the fixing belt 78 is slid against the solid heater 71″ including the convex PTC elements 130, the fixing belt 78 tends to be damaged.

That is, the solid heater 71″ is not suitable for the fixing unit 60.

As described above, the solid heater 71 according to the first exemplary embodiment includes the substrate 110 having the recesses 112, in which the PTC elements 130 are placed, respectively, with the protective layer 170 having an even and smooth (level) surface with suppressed irregularities. Hence, the PTC elements 130 are prevented from projecting toward the fixing belt 78. Furthermore, the thickness (thickness d0) of the protective layer 170 in the regions above the resistive heating bodies 120, i.e., the distance between the fixing belt 78 and each of the resistive heating bodies 120, is small. Thus, the efficiency in the heat conduction from the resistive heating bodies 120 to the fixing belt 78 is improved.

Since the protective layer 170 provided over the resistive heating bodies 120 is thin, the time required to heat the solid heater 71 to a predetermined temperature is reduced, and the power consumption by the solid heater 71 is therefore reduced. In addition, the fixing time in the image forming process is reduced.

### Method of Manufacturing Solid Heater 71

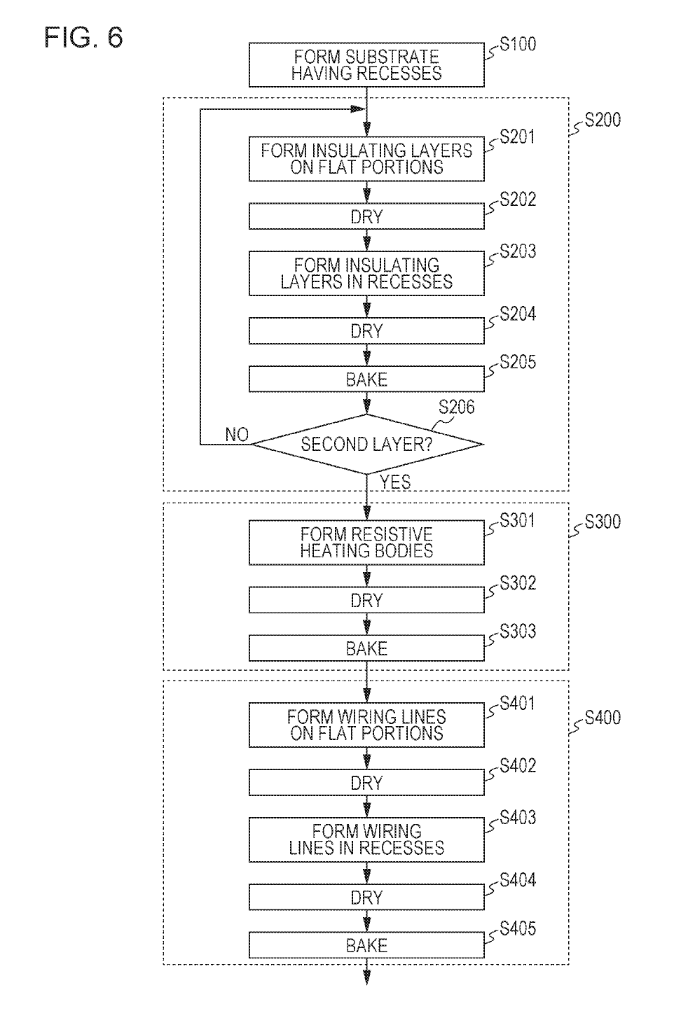

FIG. 6 is a flow chart illustrating exemplary steps of manufacturing the solid heater 71.

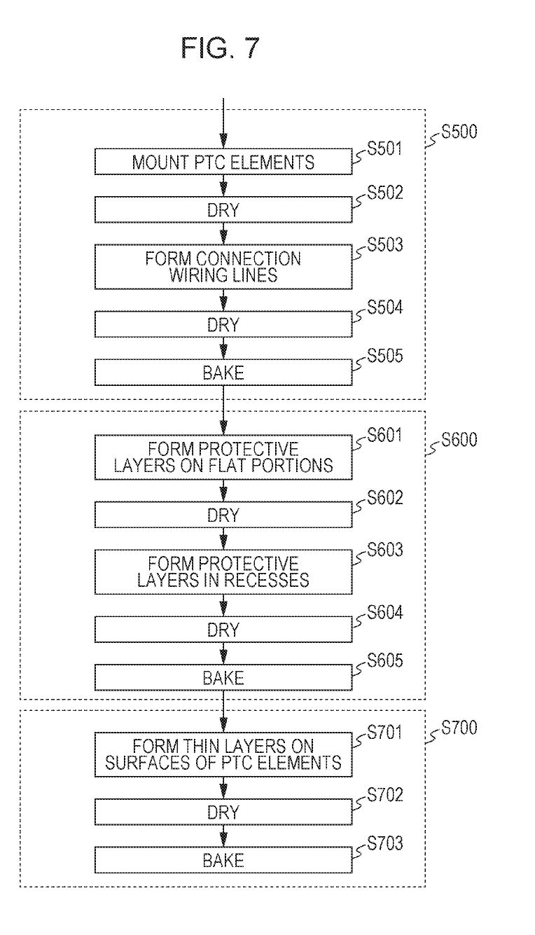

FIG. 7 is a flow chart illustrating other exemplary steps of manufacturing the solid heater 71 that follow the steps illustrated in FIG. 6.

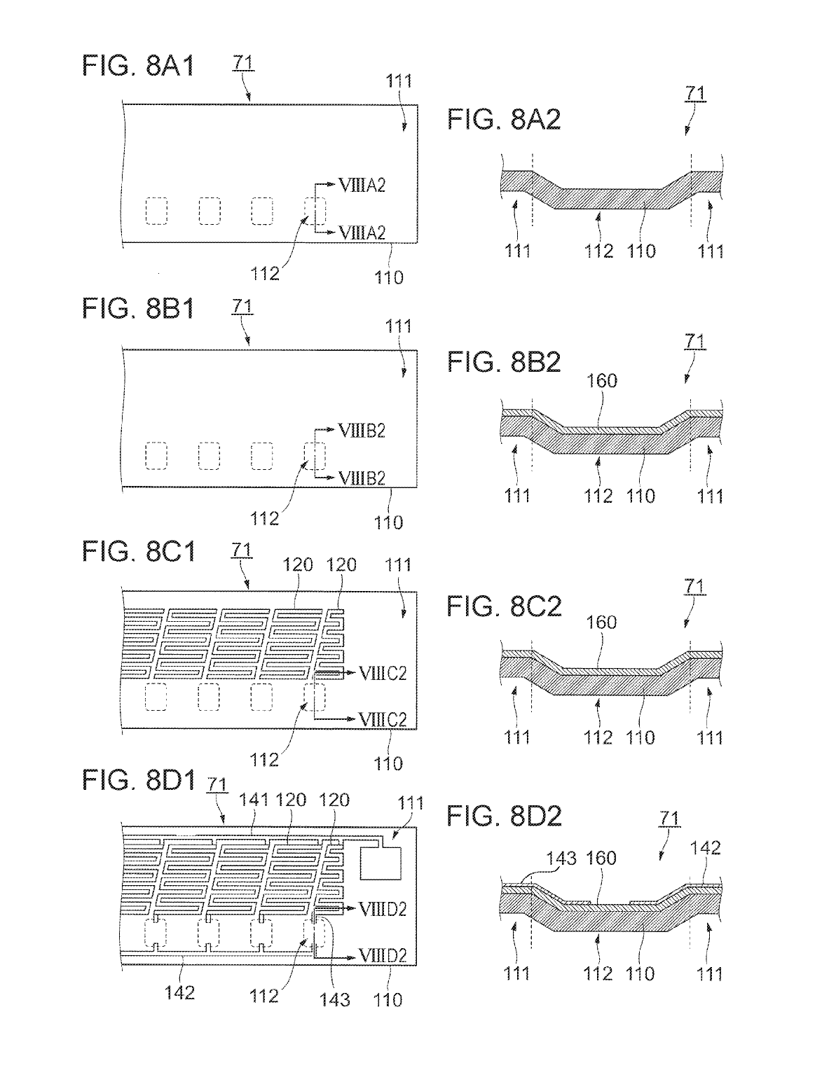

FIGS. 8A1, 8B1, 8C1, and 8D1 are top views illustrating corresponding ones of the steps of manufacturing the solid heater 71. FIGS. 8A2, 8B2, 8C2, and 8D2 are sectional views taken along respective lines VIIIA2-VIIIA2, VIIIB2-VIIIB2, VIIIC2-VIIIC2, and VIIID2-VIIID2 illustrated in FIGS. 8A1, 8B1, 8C1, and 8D1.

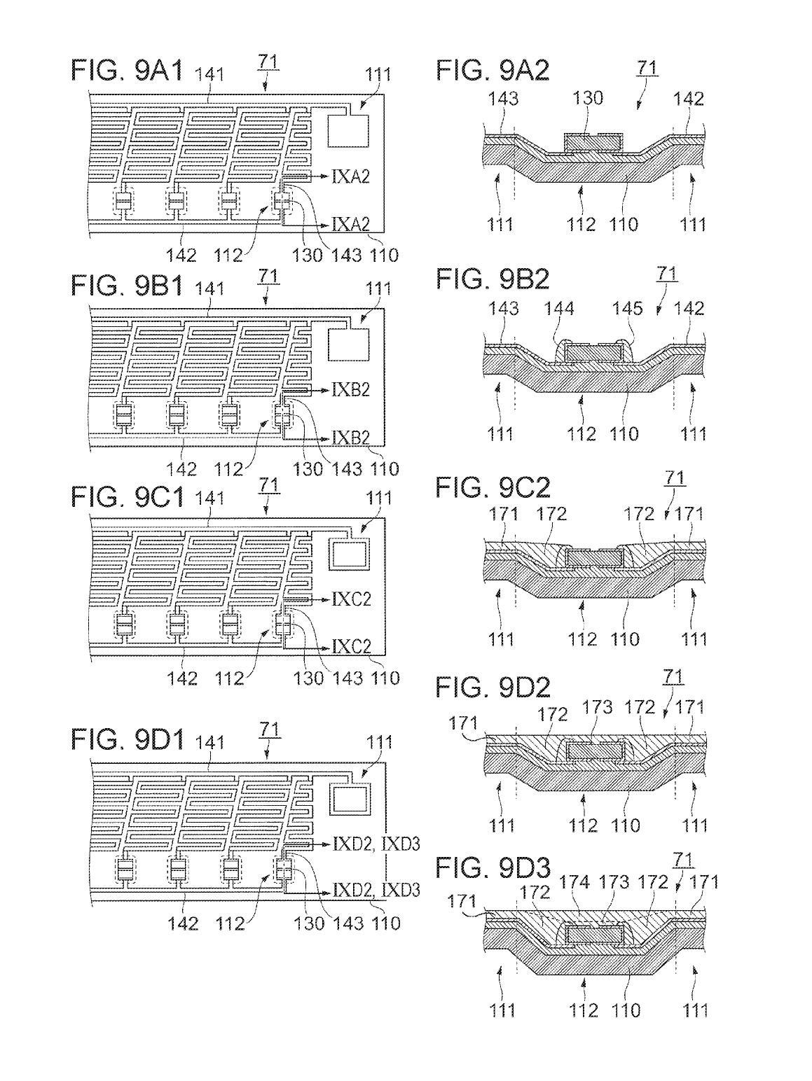

FIGS. 9A1, 9B1, 9C1, and 9D1 are top views illustrating corresponding ones of the steps of manufacturing the solid heater 71 that follow the steps illustrated in FIGS. 8A1, 8B1, 8C1, and 8D1. FIGS. 9A2, 9B2, 9C2, 9D2, and 9D3 are sectional views taken along respective lines IXA2-IXA2, IXB2-IXB2, IXC2-IXC2, IXD2-IXD2, and IXD3-IXD3 illustrated in FIGS. 9A1, 9B1, 9C1, and 9D1.

Since FIGS. 8A2, 8B2, 8C2, 8D2, 9A2, 9B2, 9C2, 9D2, and 9D3 each illustrate only a part of the substrate 110 where one of the PTC elements 130 is to be placed, the substrate 110 is illustrated as a flat member.

Referring to FIGS. 6 to 9D3, a method of manufacturing the solid heater 71 will now be described.

The method of manufacturing the solid heater 71 according to the first exemplary embodiment includes, as illustrated in FIG. 6, a step of forming a substrate having recesses (step S100) in which the substrate 110 having the recesses 112 is formed, a step of forming an insulating layer (step S200) in which the insulating layer 160 is formed, a step of forming resistive heating bodies (step S300) in which the resistive heating bodies 120 are formed, and a step of forming wiring lines (step S400) in which the wiring lines 140 (the wiring lines 141, 142, and 143) are formed. The method of manufacturing the solid heater 71 further includes, as illustrated in FIG. 7, a step of mounting PTC elements (step S500) in which the PTC elements 130 are mounted on the substrate 110, a step of forming a protective layer around the PTC elements (step S600) in which the protective layer 170 is formed around each of the PTC elements 130, and a step of sealing the PTC elements (step S700) in which the PTC elements 130 are each sealed by the protective layer 170 provided over the surface of the PTC element 130.

A combination of the step of forming a protective layer around the PTC elements (step S600) and the step of sealing the PTC elements (step S700) is occasionally referred to as a step of forming a protective layer.

In the step of forming a substrate having recesses (step S100 illustrated in FIG. 6 and FIGS. 8A1 and 8A2), for example, a plate of stainless steel (SUS) is cut into the shape of the solid heater 71, and the cut plate is bent into an arc or substantially arc shape in sectional view. Furthermore, the plate is pressed such that recesses 112 are provided at a time at respective positions where the PTC elements 130 are to be mounted. The order of performing the above processes of cutting the plate into the shape of the solid heater 71, bending the plate into an arc or substantially arc shape, and providing the recesses 112 is arbitrary.

Thus, as illustrated in FIGS. 8A1 and 8A2, a substrate 110 having recesses 112 is obtained.

Subsequently, in the step of forming an insulating layer (step S200 illustrated in FIG. 6 and FIGS. 8B1 and 8B2), an insulating layer 160 made of, for example, a glass material is formed. The glass material is glass paste and is applied to the substrate 110.

The glass paste contains glass particles, a binder that keeps the glass particles to be suspended therein, and a solvent that adjusts the viscosity of the glass paste. The glass particles are particles of a glass material whose composition has been adjusted such that the glass particles are softened at a predetermined temperature. The binder is ethyl cellulose or the like and suppresses the cohesion of the glass particles.

The glass paste that is to form the insulating layer 160 is applied to the flat portions 111 of the substrate 110 by screen printing or the like (step S201 in FIG. 6).

Screen printing is a method of forming a film of glass paste on the substrate 110 by extruding the glass paste through a screen having openings by using a squeegee.

To level (planarize) the surface of the glass paste by utilizing the fluidity of the glass paste, the film of the glass paste is left for a predetermined period of time (a leveling step). Subsequently, to evaporate the solvent, the film of the glass paste is dried in, for example, an electric oven that is set at a temperature at which the solvent evaporates (step S202 in FIG. 6).

Other drying steps to be described below are the same as the above drying step, and redundant description thereof is omitted.

Subsequently, the glass paste is further applied to the recesses 112 of the substrate 110 by using a tool such as a dispenser or a jet dispenser (step S203 in FIG. 6). The recesses 112 each have a depth of, for example, 0.25 mm. Therefore, it is difficult to bring the screen used in screen printing into contact with the bottom of each of the recesses 112. That is, the glass paste extruded through the screen is difficult to adhere to the bottom of each of the recesses 112. Hence, it is difficult to apply the glass paste with a uniform thickness in each of the recesses 112. In view of such a situation, the application of the glass plate to the recesses 112 is performed by using a dispenser or a jet dispenser.

The dispenser employs a method of ejecting the glass paste from a nozzle. Hence, it is possible to apply the glass paste to the bottom of each of the recesses 112.

The jet dispenser employs a method of ejecting the glass paste from a pressurize nozzle. Hence, in the case of the jet dispenser, the glass paste is ejected in the form of smaller droplets and by a longer distance than in the case of the above dispenser.

That is, the glass paste is applied to the flat portions 111 and to the recesses 112 in different manners.

Furthermore, to level the surface of the glass paste by utilizing the fluidity of the glass paste, the glass paste is left for a predetermined period of time (a leveling step) and is then dried so that the solvent is evaporated (step S204 in FIG. 6).

Subsequently, the glass paste applied to the flat portions 111 and to the recesses 112 is baked so that the glass particles are fused or softened to be integrated together. Specifically, the glass paste is baked (step S205 in FIG. 6) at a temperature predetermined on the basis of the characteristic of the glass particles contained in the glass paste. The baking is performed in an atmosphere containing oxygen, such as air (an oxygen atmosphere). Thus, the binder such as ethyl cellulose burns into CO₂ and is removed. Furthermore, the glass particles are softened (fused) and are integrated together, thereby forming a fine glass film.

Other baking steps to be described below are the same as the above baking step, and redundant description thereof is omitted.

Subsequently, whether or not steps S201 to S205 performed are for a second layer (second time) is checked (step S206 in FIG. 6). If steps S201 to S205 performed are for a first layer (first time), steps S201 to S205 are performed again for the second layer (second time). If steps S201 to S205 performed are for the second layer (second time), the step of forming an insulating layer (step S200) ends, and the process proceeds to the step of forming resistive heating bodies (step S300 in FIG. 6).

In the step of forming an insulating layer (step S200 in FIG. 6), steps S201 to S205 are performed twice so that two insulating layers 160 are formed. This is because of the following reason. If the insulating layer 160 is provided at a time (in one layer) and if that insulating layer 160 has any holes (pinholes), short circuits between the substrate 110 and the resistive heating bodies 120 and the wiring lines 140 (the wiring lines 141, 142, and 143) that are to be provided on the insulating layer 160 may occur through such holes (pinholes). Particularly, in a method in which the glass paste is ejected in lines or spots by using a dispenser or a jet dispenser, holes (pinholes) tend to occur between the lines or spots of the glass paste.

Hence, two insulating layers 160 are formed so that any holes (pinholes) in the first layer are covered with the second layer, whereby the occurrence of short circuits is suppressed.

Thus, the insulating layer 160 is formed on the substrate 110 as illustrated in FIGS. 8B1 and 8B2.

Subsequently, in the step of forming resistive heating bodies (step S300 illustrated in FIG. 6 and FIG. 8C1), resistive heating bodies 120 made of, for example, AgPd are formed. The resistive heating bodies 120 are not included in the section illustrated in FIG. 8C2.

As illustrated in FIG. 8C1, the resistive heating bodies 120 are formed on the flat portions 111 of the substrate 110. Therefore, resistive-heating-body paste containing AgPd with a high ratio of Pd is applied to the flat portions 111 by screen printing (step S301 in FIG. 6).

As with the glass paste, the resistive-heating-body paste contains AgPd, a binder, a solvent, and so forth. The resistive-heating-body paste may further contain glass particles so as to have improved adhesiveness with respect to the insulating layer 160.

Hence, the resistive-heating-body paste applied to the flat portions 111 of the substrate 110 by screen printing is left for a predetermined period of time so as to be leveled, and is dried in an oven or the like that is set at a predetermined temperature so that the solvent is evaporated (step S302 in FIG. 6).

Then, the resistive-heating-body paste is baked at a predetermined temperature (step S303 in FIG. 6).

Subsequently, in the step of forming wiring lines (step S400 illustrated in FIG. 6 and FIGS. 8D1 and 8D2), wiring lines 140 (wiring lines 141, 142, and 143) made of, for example, AgPd are formed. The wiring line 141 is not included in the section illustrated in FIG. 8D2.

First, wiring-line paste containing AgPd with a high ratio of Ag and that is to form the wiring line 141, some portions of the wiring line 142, and some portions of the wiring lines 143 is applied to the flat portions 111 of the substrate 110 by screen printing (step S401 in FIG. 6). As with the resistive-heating-body paste, the wiring-line paste contains AgPd, a binder, a solvent, and so forth. The wiring-line paste may further contain glass particles so as to have improved adhesiveness with respect to the insulating layer 160.

Then, after a leveling step is performed, the wiring-line paste is dried so that the solvent is evaporated (step S402 in FIG. 6).

Subsequently, the wiring-line paste that is to form other portions of the wiring lines 140 (the remaining portions of the wiring lines 142 and 143 that are to be formed in the recesses 112) are applied to the recesses 112 of the substrate 110 by using a dispenser or a jet dispenser (step S403 in FIG. 6). The wiring lines 140 in the recesses 112 are formed while the wiring-line paste applied to the flat portions 111 is observed through a microscope or the like. Thus, the wiring lines 140 formed on the flat portions 111 and the wiring lines 140 formed in the recesses 112 are precisely connected to each other. If the positions of the wiring lines 140 are recognized from an image taken by the microscope, the formation of the wiring lines 140 may be performed automatically.

Then, after a leveling step is performed, the wiring-line paste is dried so that the solvent is evaporated (step S404 in FIG. 6).

Furthermore, the wiring-line paste is baked (step S405 in FIG. 6), whereby the wiring lines 140 (the wiring lines 141, 142, and 143) are obtained.

Thus, as illustrated in FIGS. 8D1 and 8D2, the wiring lines 140 (the wiring lines 141, 142, and 143) are formed on the substrate 110. The wiring line 141 is not included in the section illustrated in FIG. 8D2.

Subsequently, in the step of mounting PTC elements (step S500 illustrated in FIG. 7 and FIGS. 9A1 and 9A2), PTC elements 130 are placed in the respective recesses 112 of the substrate 110.

First, insulating glass paste is applied to positions in the recesses 112 of the substrate 110 where PTC elements 130 are to be placed. The application of the insulating glass paste may be performed by using a dispenser or a jet dispenser. Then, PTC elements 130 are placed on the glass paste (step S501 in FIG. 7), and the glass paste is dried so that the solvent contained in the glass paste is evaporated (step S502 in FIG. 7).

Subsequently, wiring lines 144 that each connect the electrode 132 of a corresponding one of the PTC elements 130 and a corresponding one of the wiring lines 143 to each other and wiring lines 145 that each connect the electrode 133 of a corresponding one of the PTC elements 130 and the wiring line 142 to each other are formed (step S503 in FIG. 7). The wiring lines 144 and 145 are formed by ejecting connection-wiring-line paste from a dispenser or a jet dispenser. As with the wiring-line paste, the connection-wiring-line paste contains AgPd, a binder, a solvent, and so forth.

The positions where the wiring lines 144 and 145 are to be formed may be determined by observing the position of ejection from the dispenser or the jet dispenser through a microscope or the like. Then, after a leveling step is performed, the connection-wiring-line paste is dried so that the solvent is evaporated (step S504 in FIG. 7).

Furthermore, the glass paste provided for the mounting of the PTC elements 130 on the substrate 110 and the connection-wiring-line paste that is to form the wiring lines 144 and 145 are baked (step S505 in FIG. 7).

Considering the heat-resistant temperature (about 600° C.) of the PTC elements 130, the glass paste for fixing the PTC elements 130 to the substrate 110 and the connection-wiring-line paste may be baked at or below the heat-resistant temperature of the PTC elements 130.

Subsequently, the step of forming a protective layer around the PTC elements (step S600 illustrated in FIG. 7 and FIGS. 9C1 and 9C2) is performed. As with the case of the insulating layer 160, portions of the protective layer 170 above the flat portions 111 of the substrate 110 and portions of the protective layer 170 above the recesses 112 are formed in different manners.

First, glass paste that is to form protective layers 171 (see FIG. 9C2) as portions of the protective layer 170 is applied to the flat portions 111 of the substrate 110 by screen printing or the like (step S601 in FIG. 7). Note that the glass paste is not applied to portions of the wiring lines 141 and 142 that are to become the terminals 150 (the terminals 151 and 152).

Then, after a leveling step is performed, the glass paste is dried (step S602 in FIG. 7).

Subsequently, glass paste that is to form protective layers 172 as remaining portions of the protective layer 170 is applied to areas around the PTC elements 130 placed in the recesses 112. The PTC elements 130 are placed in the respective recesses 112 provided in the substrate 110. Hence, there are gaps around the PTC elements 130. Therefore, the gaps around the PTC elements 130 are filled with the glass paste ejected from a dispenser or a jet dispenser (step S603 in FIG. 7). In this step, the glass paste is not applied to (the upper surfaces of) the PTC elements 130. That is, the tops of the body portions 131 of the PTC elements 130 are kept uncovered with the glass paste. The reason for this will be described later.

Then, after a leveling step is performed, the glass paste is dried (step S604 in FIG. 7).

If the glass paste is applied only to the recesses 112 in which the PTC elements 130 are placed, a part of the surface of each of the PTC elements 130 only needs to be kept uncovered, with the other part of the surface of the PTC element 130 being covered with the glass plate.

Subsequently, the glass paste provided above the flat portions 111 and around the PTC elements 130 in the recesses 112 is baked (step S605 in FIG. 7).

Thus, as illustrated in FIGS. 9C1 and 9C2, the protective layers 171 and 172 as portions of the protective layer 170 are formed in areas excluding the upper surfaces of the PTC elements 130 and the portions of the wiring lines 141 and 142 that are to become the terminals 151 and 152.

Subsequently, the step of sealing the PTC elements (step S700 illustrated in FIG. 7 and FIGS. 9D1 and 9D2) is performed.

Glass paste that is to form protective layers 173 as portions of the protective layer 170 is thinly applied to the surfaces of the PTC elements 130 (step S701 in FIG. 7) that have not been covered with the glass paste in the step of forming a protective layer around the PTC elements. In this step also, the glass paste may be ejected from a dispenser or a jet dispenser.

Then, after a leveling step is performed, the glass paste is dried (step S702 in FIG. 7), and the glass paste is baked (step S703 in FIG. 7).

Thus, the PTC elements 130 are covered with the protective layer 170 (the protective layers 172 and 173).

If the glass paste is applied only to the recesses 112 in which the PTC elements 130 are placed, the uncovered part of the surface of each of the PTC elements 130 only needs to be covered with the glass paste.

As described above, in the solid heater 71 according to the first exemplary embodiment, the step of forming a protective layer is divided into the following two steps: the step of forming a protective layer around the PTC elements (step S600 in FIG. 7) in which the glass paste is applied to areas excluding the surfaces of the PTC elements 130 and is baked, and the step of sealing the PTC elements (step S700 in FIG. 7) in which the glass paste is thinly applied to the surfaces of the PTC elements 130 and is baked.

This is because the PTC elements 130 are each made of an oxide, such as barium titanate (BaTiO₃), containing a slight amount of rare earth.

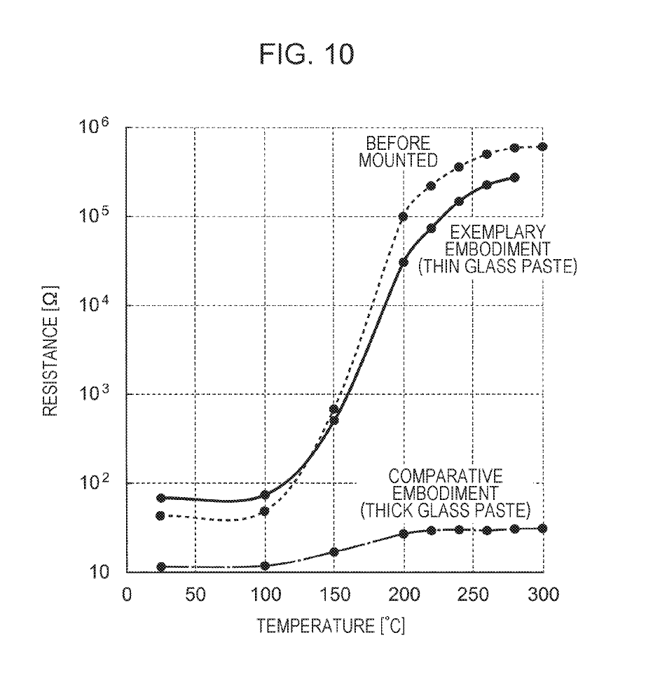

FIG. 10 is a graph illustrating the characteristic of the PTC elements 130. The solid line represents the characteristic of the PTC elements 130 included in the solid heater 71 according to the first exemplary embodiment (denoted simply as EXEMPLARY EMBODIMENT in FIG. 10). The broken line represents the characteristic of the PTC elements 130 that are yet to be mounted on the substrate 110 (denoted simply as BEFORE MOUNTED in FIG. 10). The dotted-chain line represents the characteristic of the PTC elements 130 covered with a thick layer of baked glass paste (denoted as COMPARATIVE EMBODIMENT in FIG. 10).

Herein, the term “thick layer of baked glass paste” refers to a layer of glass paste that is thicker than the layer of glass paste provided on the surfaces of the PTC elements 130 illustrated in FIGS. 9D1 and 9D2.

The resistance value of the PTC elements 130 that are yet to be mounted on the substrate 110 shows a four-digit increase with a rise of temperature from room temperature (25° C.) to 300° C. The resistance value of the PTC elements 130 according to the first exemplary embodiment represented by the solid line shows a three-and-a-half-digit increase with the same rise of temperature. The characteristic of the PTC elements 130 according to the first exemplary embodiment is slightly lower than the characteristic of the PTC elements 130 that are yet to be mounted on the substrate 110.

In contrast, in the comparative embodiment represented by the dotted-chain line, the change in the resistance value is only 7 kΩ, with respect to the same rise of temperature, which is a far smaller increase than the increase observed in the case of the PTC elements 130 that are yet to be mounted on the substrate 110. Moreover, the PTC elements 130 according to the comparative embodiment do not function as PTC elements that suppress the overheating of the solid heater 71.

As illustrated in FIGS. 9C1 and 9C2, if the glass paste is baked with the surfaces of the PTC elements 130 uncovered with the glass paste, the characteristic of the PTC elements 130 is the same as the characteristic of the PTC elements 130 that are yet to be mounted on the substrate 110, that is, there is no deterioration in the characteristic of the PTC elements 130.

When the glass paste is baked, the binder such as ethyl cellulose burns, which tends to produce a reducing atmosphere. Therefore, oxygen is released from the PTC elements 130, which are made of oxide, and the characteristic of the PTC elements 130 is deteriorated. The baking of the glass paste is performed in an atmosphere, such as air, containing oxygen. Hence, in the case where the baking is performed with the surfaces of the PTC elements 130 being uncovered with the glass paste, even if oxygen is released from the PTC elements 130, fresh oxygen is supplied to the PTC elements 130 from the atmosphere containing oxygen. Therefore, the characteristic of the PTC elements 130 is less likely to be deteriorated.

The portion of each of the PTC elements 130 that is not covered with the glass paste only needs to have a size that allows the PTC element 130 to be supplied with a satisfactory amount of oxygen from the atmosphere containing oxygen so that the characteristic of the PTC element 130 is less likely to be deteriorated. Hence, the uncovered portion of each PTC element 130 is not limited to the upper surface and may be a part of the upper surface or a side surface.

However, in the case where a thick layer of glass paste is provided over the surfaces of the PTC elements 130 (as in the comparative embodiment), a large amount of oxygen is released from the PTC elements 130 when the glass paste is baked, whereas the thick layer of glass blocks the supply of oxygen. Therefore, the characteristic of the PTC elements 130 is deteriorated more.

In contrast, in the case where a thin layer of glass paste is provided over the surfaces of the PTC elements 130 (as in the first exemplary embodiment), the amount of oxygen that is released from the PTC elements 130 during the baking of the glass paste is suppressed to a low level. Therefore, even if the supply of oxygen is blocked, the deterioration in the characteristic of the PTC elements 130 is suppressed to a low level.

In view of the above, in the case where the PTC elements 130 are covered with (embedded in) the protective layer 170 (a glass layer) formed by baking the glass paste, the thickness of the glass paste applied to the surfaces of the PTC elements 130 is set such that the deterioration in the characteristic of the PTC elements 130 due to the release of oxygen falls within an allowable range.

If a part of the surface of each of the PTC elements 130 are uncovered, the amount of glass paste to be applied to the uncovered part is set such that the deterioration in the characteristic of the PTC elements 130 due to the release of oxygen falls within an allowable range.

If the thickness of the glass paste applied to the surfaces of the PTC elements 130 is within the above range but is too thin to serve as the protective layer 170 that protects the PTC elements 130, another layer of glass paste may be formed over the thin layer of baked glass paste and be baked, so that the thickness of the protective layer 170 above the PTC elements 130 is increased.

FIG. 9D3 illustrates a case where each recess 112 of the substrate 110 is deeper than the recess 112 illustrated in FIG. 9D2 and the protective layer 170 provided above the PTC element 130 is thicker than the protective layer 170 illustrated in FIG. 9D2. In such a case, the step of sealing the PTC elements includes the following two steps: a step of forming a protective layer 173 as a portion of the protective layer 170 by thinly applying glass paste to each PTC element 130, and a step of forming another protective layer 174 as another portion of the protective layer 170 by applying glass paste over the protective layer 173.

That is, the protective layer 170 illustrated in FIG. 9D3 includes the protective layers 171, 172, 173, and 174. The protective layer 174 may be extended over the protective layers 171. The protective layer 174 may be formed by screen printing.

If a thin layer of glass paste is provided over each of the PTC elements 130 and is baked and another layer of glass paste is provided over the thin layer of glass paste and is baked, the thin glass film (the protective layer 173) that has become fine as a result of baking serves as a barrier (an oxygen barrier) that blocks oxygen and suppresses the release of oxygen from the PTC element 130. Hence, the further deterioration in the characteristic of the PTC elements 130 is suppressed. That is, the characteristic of the PTC elements 130 according to the first exemplary embodiment illustrated in FIG. 10 is retained.

The glass paste used for forming the insulating layer 160 and the glass paste used for forming the protective layer 170 may be of the same composition or of different compositions with different softening temperatures (glass-transition temperatures). Moreover, the protective layers 171, 172, 173, and 174 that form the protective layer 170 may be of different compositions.

The glass paste ejected from a dispenser or a jet dispenser may be spread by using a brush or the like. Likewise, the glass paste provided by screen printing may be spread by using a brush or the like.

While the above manufacturing method concerns a case where the PTC elements 130 are employed as resistive elements each having a positive temperature coefficient, the above manufacturing method is also applicable to a case employing thermistors of another kind.

For example, a negative-temperature-coefficient (NTC) element that is a resistive element having a negative temperature coefficient is obtained by mixing any of transition-metal oxides such as nickel (Ni), manganese (Mn), cobalt (Co), and iron (Fe) and sintering the mixture.

For another example, a critical-temperature resistor (CTR) whose resistance starts to drop rapidly when the temperature of the resistor goes over a certain point is obtained by mixing a vanadium oxide and an additive and sintering the mixture.

When it is attempted to seal any of the above thermistors containing oxides with a protective layer made of baked glass paste, oxygen may be released from the thermistor, as in the case of the PTC element 130. Hence, the following two steps are performed: a first coating step in which the surface of the thermistor excluding a part thereof is covered with glass paste and the glass paste is baked, and a second coating step in which the uncovered part of the surface of the thermistor is covered with the glass paste and the glass paste is baked. Thus, the deterioration in the characteristic of the thermistor is suppressed.

### Second Exemplary Embodiment

In the first exemplary embodiment, the substrate 110 has the recesses 112 provided at the respective positions where the PTC elements 130 are placed.

In a second exemplary embodiment, a continuous recess 113 is provided in a mounting area for the plural PTC elements 130 such that the continuous recess 113 receives the plural PTC elements 130.

The second exemplary embodiment is the same as the first exemplary embodiment except the solid heater 71. Therefore, a solid heater 71 according to the second exemplary embodiment will now be described.

### Solid Heater 71

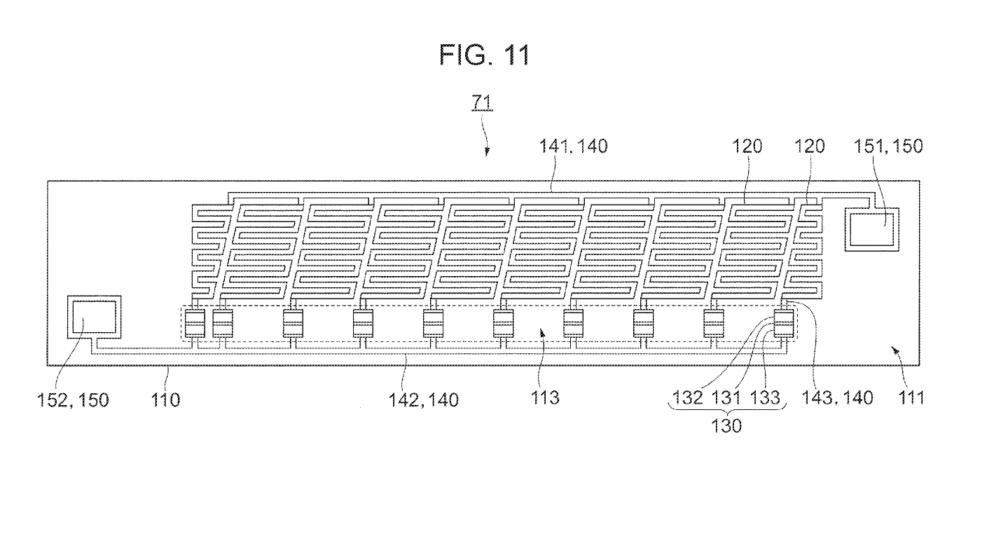

FIG. 11 is a top view of the solid heater 71 according to the second exemplary embodiment seen in the direction of arrow IIIA illustrated in FIG. 2.

As illustrated in FIG. 11, the PTC elements 130 are arranged along one longitudinal side (the lower side in FIG. 11) of the substrate 110 and side by side in the longitudinal direction of the substrate 110, and a portion of the substrate 110 where the PTC elements 130 are arranged is shaped as the continuous recess 113.

The continuous recess 113 has a larger size than each of the recesses 112 according to the first exemplary embodiment. That is, the continuous recess 113 is formable with lower accuracy than the recess 112. Hence, it is easier to process the substrate 110 in providing the continuous recess 113 than in providing the recess 112.

It is not necessary to place all the PTC elements 130 in one continuous recess 113. Two or more PTC elements 130 may be placed in one continuous recess 113.

The solid heater 71 according to the second exemplary embodiment is manufacturable by the method of manufacturing the solid heater 71 according to the first exemplary embodiment. Therefore, description of the manufacturing method is omitted.

In the case of the continuous recess 113, gaps between the PTC elements 130 are filled with the protective layers 172 (see FIGS. 9C2 and 9D2) included in the protective layer 170. Hence, to manufacture the solid heater 71 according to the second exemplary embodiment, a larger amount of glass paste that is to form the protective layer 170 is necessary than in the case of manufacturing the solid heater 71 according to the first exemplary embodiment.

In the solid heater 71 according to each of the first and second exemplary embodiments, the insulating layer 160 and the protective layer 170 are each formed by baking the glass paste in an atmosphere containing oxygen.

Instead of the glass paste, paste containing insulating ceramic particles may be used, and the paste may be baked in an atmosphere containing oxygen, whereby the insulating layer 160 and/or the protective layer 170 may be formed. The baking in an atmosphere containing oxygen allows the binder, such as ethyl cellulose, to burn and to be removed. Therefore, the ceramic particles are sintered together.

In the solid heater 71 according to each of the first and second exemplary embodiments, the PTC element 130 is connected in series to each of all resistive heating bodies 120. However, it is not necessary to connect the PTC elements 130 to the resistive heating bodies 120 in an area corresponding to a portion of the fixing belt 78 where the sheet P always passes regardless of the size of the sheet P.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a heating member that includes
a substrate having a substantially flat portion and a recess in a surface on one side,
a heating body provided on the substantially flat portion of the substrate and that generates heat with a supply of electric current,
a resistive element provided in the recess of the substrate and that is connected in series to the heating body, the resistive element having a positive temperature coefficient, and
a protective layer provided over the heating body and the resistive element and that protects the heating body and the resistive element;
a belt member that is heated by being in contact with the surface, on the one side, of the substrate of the heating member, the belt member being rotatable; and
a pressing member that is pressed against the belt member and forms a nip part.

2. The fixing device according to claim 1, wherein the protective layer has a substantially level surface.

3. The fixing device according to claim 1, wherein the surface, on the one side, of the substrate of the heating member has a substantially arc shape in a direction of rotation of the belt member.

4. The fixing device according to claim 1,
wherein the heating body is one of a plurality of heating bodies,
wherein the resistive element is one of a plurality of resistive elements, and
wherein the recess of the substrate is provided for each of the resistive elements.

5. The fixing device according to claim 1,
wherein the heating body is one of a plurality of heating bodies,
wherein the resistive element is one of a plurality of resistive elements, and
wherein the recess of the substrate is provided for each group of at least two resistive elements.

6. An image forming apparatus comprising:
a transfer portion where a toner image is transferred to a recording medium; and
a fixing portion,
the fixing portion including
a heating member that includes a substrate having a substantially flat portion and a recess in a surface on one side, a heating body provided on the substantially flat portion of the substrate and that generates heat with a supply of electric current, a resistive element provided in the recess of the substrate and that is connected in series to the heating body, the resistive element having a positive temperature coefficient, and a protective layer provided over the heating body and the resistive element and that protects the heating body and the resistive element;
a belt member that is heated by being in contact with the surface, on the one side, of the substrate of the heating member, the belt member being rotatable; and
a pressing member that is pressed against the belt member and forms a nip part,
the fixing portion fixing the toner image on the recording medium that is held in the nip part.

7. A heating device comprising:
a substrate having a substantially flat portion and a recess in a surface on a side facing a heating object;
a heating body provided on the substantially flat portion of the substrate and that generates heat with a supply of electric current, the heating body heating the heating object;
a resistive element provided in the recess of the substrate and that is electrically connected in series to the heating body, the resistive element having a positive temperature coefficient; and
a protective layer provided over the heating body and the resistive element and that protects the heating body and the resistive element.

8. The heating device according to claim 7, wherein the protective layer has a substantially level surface.

9. The heating device according to claim 7,
wherein the heating body is one of a plurality of heating bodies,
wherein the resistive element is one of a plurality of resistive elements, and
wherein the recess of the substrate is provided for each of the resistive elements.

10. The heating device according to claim 7,
wherein the heating body is one of a plurality of heating bodies,
wherein the resistive element is one of a plurality of resistive elements, and
wherein the recess of the substrate is provided for each group of at least two resistive elements.
